(19) United States
(12) Patent Application Publication
(10) Pub. No.: US 2003/0193203 A1
(43) Pub. Date: Oct. 16, 2003

(54) Universal carrier for construction elements

(76) Inventor: Dennis DuBois, Las Vegas, NV (US)

Correspondence Address: QUIRK & TRATOS, 3773 HOWARD HUGHES PARKWAY, SUITE 500 NORTH, LAS VEGAS, NV, 89109, US

(21) Appl. No.: 10/121,540

(22) Filed: Apr. 10, 2002

(51) Int. Cl. B65G 7/12

(52) U.S. Cl. 294/15

(57) ABSTRACT

A primary carrier assembly includes a generally rectangular central frame defined by a pair of substantially parallel tubular segments joined at one ends thereof by a padded cross piece conformed for receipt in the armpit of a person and bridged proximate the other ends thereof by an offset transverse handle piece. A panel carrier assembly is releasably engaged to said other ends of said tubular segments and is defined by equally spaced, parallel posts conformed for receipt in the corresponding other ends of said tubular segments at the upper ends thereof and affixed at their lower ends to a transverse channel. The traverse piece is conformed to support panel pieces of material. In another embodiment for carrying long articles, two hangers are suspended from ends of a rod secured within said traverse channel. The primary carrier assembly can be disassembled and integrated into a conventional dolly as well.

### FIELD OF THE INVENTION

The present invention relates to lifting devices, and more particularly to an ensemble of cooperating parts which can be combined into various carrier assembly combinations useful in moving construction elements.

### DESCRIPTION OF THE PRIOR ART

In the construction industry the movement of structural pieces that eventually form the final structure is a constant activity. This effort is rendered particularly difficult by the clutter and obstacles that are always present in an unfinished structure. In this cluttered construction setting one needs to move drywall panels to the respective locations where they are to be attached, exterior panels to their locations along the building exterior, and various structural pieces such as headers, beams, joists and wall studs to those places where they are finally fastened. In each instance, the use of labor is maximized by the use of structural components that in themselves are at the upper limit of manipulative convenience and the movement thereof in this cluttered setting is a substantial and continuing task.

Accordingly, all sorts of carriers and lifting structures have been devised in the past which in one way or another assist in the movement of construction pieces through the cluttered paths of a construction site. Examples of such prior art carriers and lifting aids can be found in the U.S. Pat. Nos. 4,177,911 to Griffin; 5,988,659 to Young; 3,761,107 to Docherty et al; 5,794,998 to Lapierre; and others. While suitable for the purposes intended, each of the foregoing and the others describe carrying or handling tools conformed for particular structural piece. In consequence, the already burdened construction site is further cluttered by these numerous specialized tools which in many instances duplicate parts or portions thereof.

Those skilled in the art will appreciate that while there may be a variety of architectural or structural pieces that is needed in the course of assembly of a dwelling or another structure, the musculature and the skeletal architecture of the construction worker is generally constant. Most of the foregoing prior art devices fail to appreciate this constant and frequently duplicate components or portions that are dictated by human musculature in structures of various applications. As result duplication and waste is inherent and for that reason lifting tools and carrier assembly that can be variously conformed are universally desired. It is one such variously conformed lifting assembly that is disclosed herein.

### SUMMARY OF THE INVENTION

Accordingly it is the general purpose and object of the present invention to provide a carrier assembly comprising a plurality of parts that can be selectively interconnected for various specialized applications.

Other objects of the invention are to provide an adaptable carrier assembly useful in the movement of various architectural components.

Yet further objects of the invention are to provide a carrier assembly that can be conformed for various uses.

Briefly these and other objects are accomplished within the present invention by providing a primary carrier frame in the form of a first set of two interconnected, parallel tubular segments adjustably affixed at the upper end thereof to a cushioned transverse piece that may be received in the armpit of the user and a lower end thereof adjustably engaging an upper end of a second set of telescoping parallel tubular segments affixed at the lower end thereof to an elongated U-shaped traverse element. An offset, transverse, tubular handle piece bridges the first set of parallel segments proximate their lower ends to form a generally rectangular carrier structure onto which other specialized carrying attachments can be mounted. The traverse handle piece further includes an integrated handle member.

The U-shaped traverse channel is ideal for carrying panel items, including plywood, drywall and similar sized building materials. With a first carrying method, carrying is accomplished by placing at least one piece of building material within the U-shaped traverse element, placing the cushioned traverse piece under a user's armpit and grasping the tubular handle piece, namely the handle member, that is positioned away from the user's body. In this manner, the building material is supported by the U-shaped element and is positioned between the user's body and the primary carrier frame. The second set of telescoping parallel tubular segments can be adjusted to increase or decrease the distance between the user's armpit and the U-shaped element thereby allowing users of unique size to benefit from the present invention. Moreover, materials of unique size can be comfortably secured by adjusting the second set of telescoping parallel tubular segments.

A second carrying method comprises placing the cushioned traverse piece adjacent an outer shoulder such that the building material (e.g. plywood) is distanced from a user's body by the carrier frame. In this manner, the carrier frame is between the user's body and the building material with the user's adjacent arm grasping the handle piece, adjacent the user's body, while preferably supporting the building material with an opposite arm. This arrangement facilitates a user's ability to climb stairs or maneuver around other obstacles.

In a second embodiment, an elongated rod is affixed within the U-shaped channel and extends in both directions parallel the U-shaped channel. Hangers are removably attached to each end of the rod and provide means for carrying elongated structural materials, including 2×4s, 4×6s, PVC piping and related articles. In this manner, the elongated structural materials are carried and transported in the same manner as the first method of carrying panel-like structures disclosed above. In other words, the elongated structure materials are distanced from the user's body by the carrier frame. Alternatively, the elongated rod is inserted through the traverse handle piece. A stop circumscribing the elongated rod insures the elongated rod is positioned accurately and an oppositely located pin and aperture arrangement secures the rod in position.

Another attachment fixture that can be mounted to the primary frame is conformed as a dolly carriage defined by two vertical tubes that are receivable in the primary frame. The cushioned handle and the second set of telescoping parallel tubular segments are disjoined and the first set of parallel interconnected tubular segments is turned over such that the handle piece is on top. The lower end is now engaged to the two vertical tubes which are joined to a pair of dolly wheels and provided with an outwardly extending support platform. The dolly is useful according to its conventional use, being provided with a cantilevered pick-up surface extending from between the dolly wheels. In addition, a rotatable pick-up extension provides a means for extending the lifting area for transporting even larger structures.

### BRIEF DESCRIPTION OF THE DRAWINGS

FIG. 1 is a perspective illustration showing the primary carrier unit;

FIG. 2 shows the unit of FIG. 1 being used;

FIG. 3 shows the unit of FIG. 1 being used in an alternative fashion;

FIG. 4A is a perspective illustration showing another embodiment of the primary carrier unit implemented to carry elongated structural materials;

FIG. 4B is a perspective illustration showing an alternative embodiment of the primary carrier unit implemented to carry elongated structural materials;

FIG. 5 shows a hanger used to carry elongated structural materials as shown in FIG. 4;

FIG. 6 shows the embodiment of FIG. 4 being used;

FIG. 7 shows individual elements of the present invention used to facilitate the various embodiments;

FIG. 8 shows a front view of a dolly embodiment of the present invention; and

FIG. 9 shows a rear view of a dolly embodiment of the present invention.

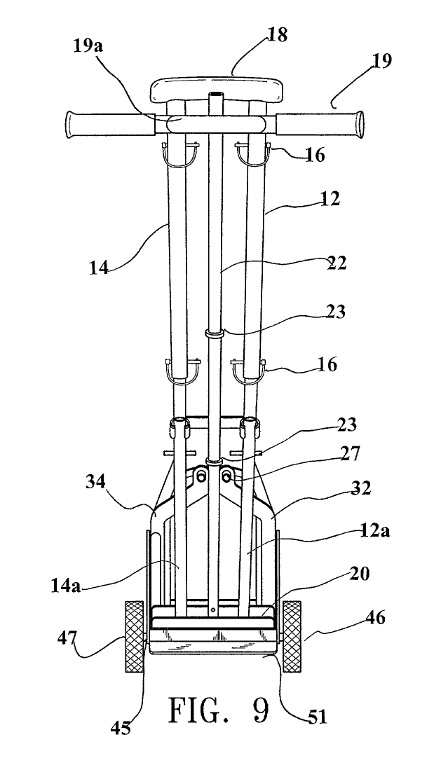

### DESCRIPTION OF THE PREFERRED EMBODIMENT

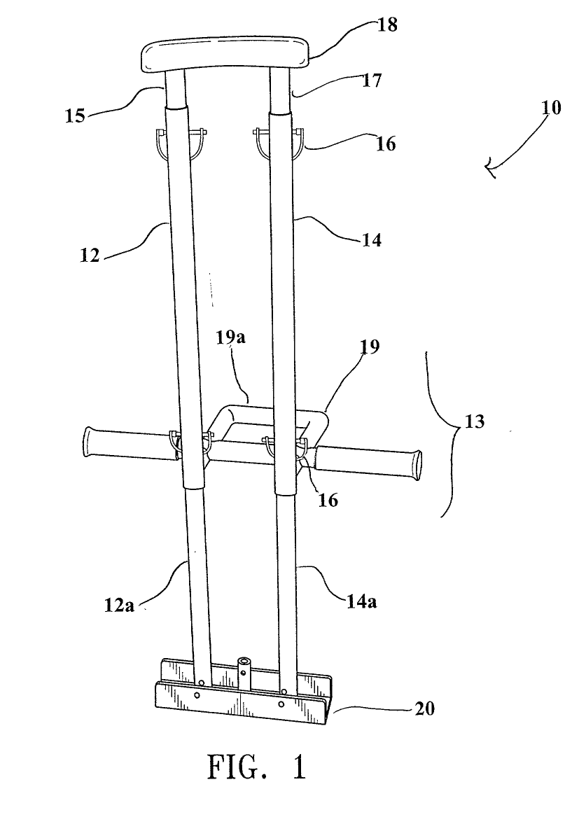

As shown in FIGS. 1 through 3, the inventive carrier assembly, generally designated by the numeral 10, is defined by a two member central frame indicated generally at 11 comprising a first set of parallel tubular segments 12 and 14 and a second set of parallel tubular segments 12a and 14a adjustably engaged to one another. Upper ends of the first pair of tubular segments 12 and 14 are further adjustably engaged to tubular segments 15, 17 of a padded cross piece 18. The lower ends of segments 12 and 14 are bridged by an offset, transverse, handle piece 19 spaced from the cross piece 18 by the typical dimension of a human arm. The traverse handle piece 19 further incorporates a void defining handle member 19A extending therefrom. To provide length adjustment the engagement of segments 12 and 14 to both 12a and 14a and 15 and 17 are each formed as telescoping structures, each telescopic receipt is provided with elongated pins 16 respectively engaging a selected one of a row of drillings present on each of the tubular segments 12, 14, 12a, 14a, 15 and 17. In this manner, the dimension between handle piece 19 and the cross piece 18 can be telescopically altered to fit the anatomy of the specific user by adjusting the padded cross piece 18 and/or the interaction between the first set 12 and 14 and second set of parallel tubular segments 12a and 14a. The second set of parallel tubular segments 12a and 14a are joined at lower ends by a U-shaped traverse channel 20 for use as disclosed below.

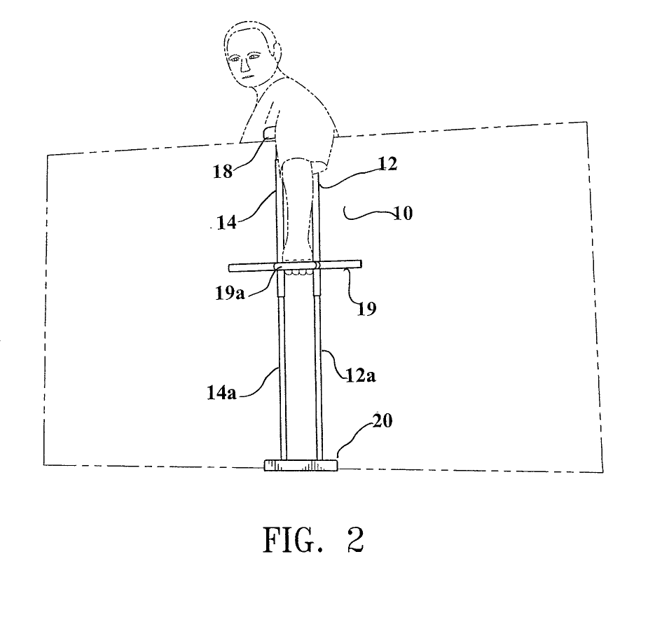

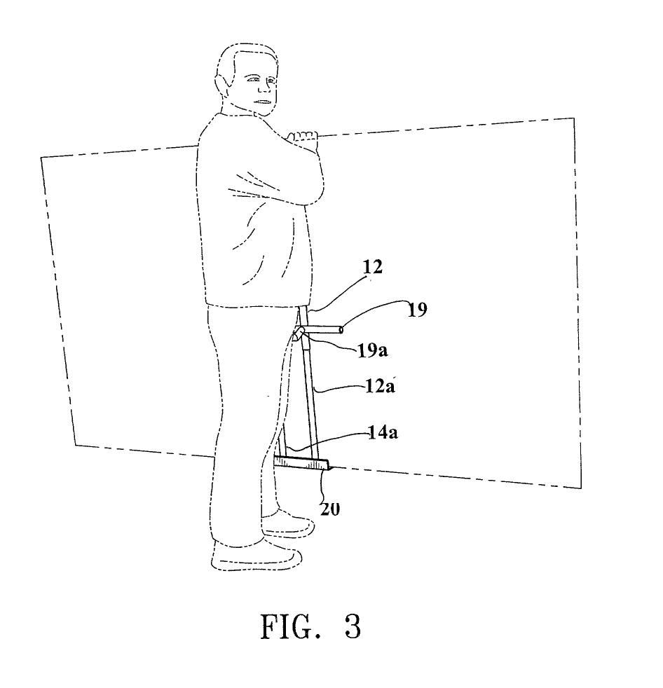

Now referring to FIGS. 2 and 3, the carrier assembly 10 can be used adjacent a user's body or distanced from the user's body such that the material being carried is between the carrier assembly 10 and the user's body. It has been found that traversing stairs or other obstacles may be more easily and safely accomplished by placing the carrier assembly adjacent the user's body while supporting the material being carried with an opposite hand as shown in FIG. 3. However, the carrying method is ultimately at the discretion its users.

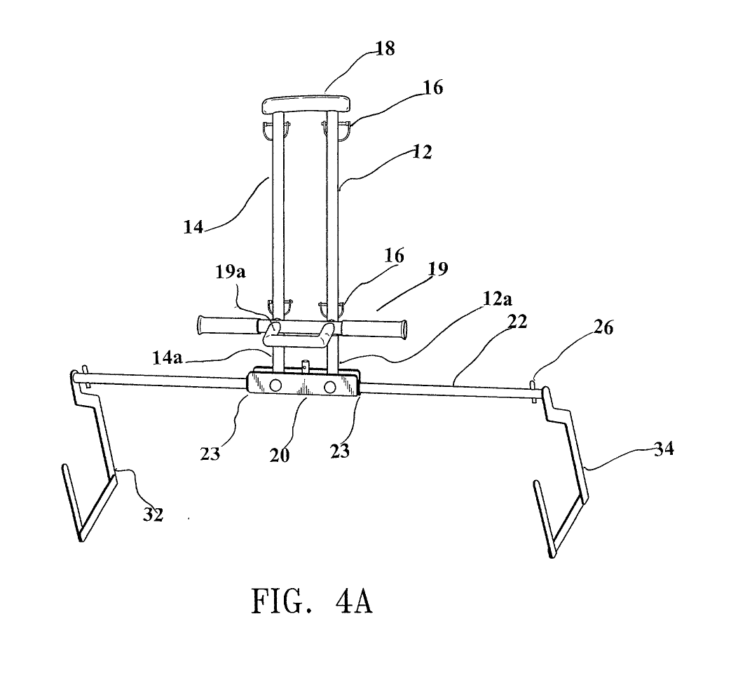

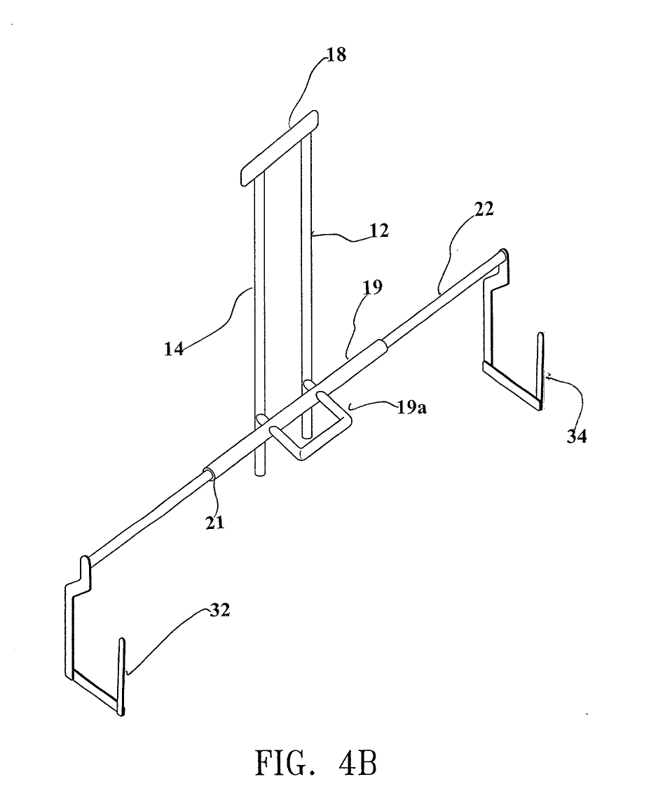

The same structural combination may also be useful in assisting the movement of long articles such as beams or joists. Specifically as shown in FIG. 4A, pivotally suspended hangers 32 and 34 are engaged to ends of an elongated rod 22 that is secured within the U-shaped channel 20. The ends of the rod 22 are spaced sufficiently to allow long articles to be securely supported therebetween. The rod 22 is secured longitudinally by means of two spaced ribs 23 which embrace both ends of the U-shaped channel 20. The rod 22 is further secured within the U-shaped channel 20 by means of elongated pins 24 inserted through spaced drillings 25 in both upwardly extending surfaces of the U-shaped channel 20 and corresponding drillings in the second set of parallel tubular segments 12a and 14a so as the prevent the rod 22 from shifting vertically. FIG. 4B shows an alternative embodiment whereby the elongated rod 22 is inserted through the traverse handle piece 19 rather than being secured within the U-shaped channel 20. A stop 21 circumscribing the rod 22 provides an alignment means. A pin and aperture arrangement secures the rod 22 in position.

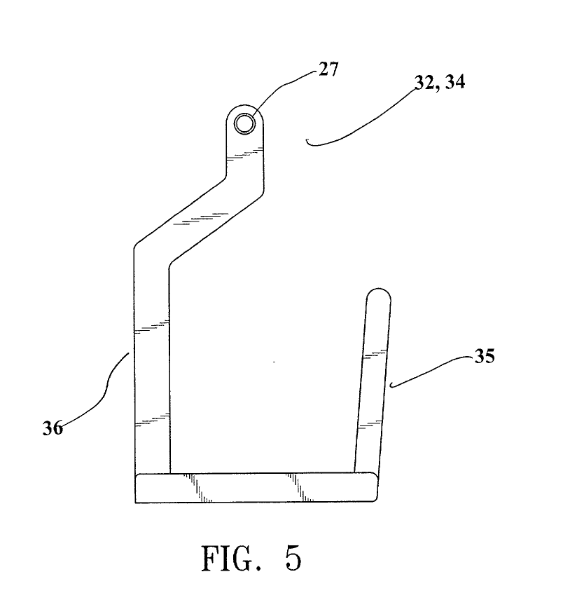

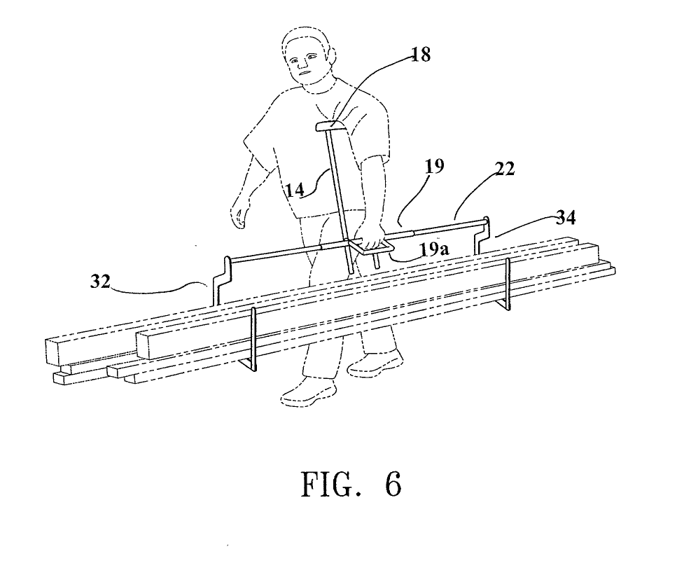

FIG. 5 shows the design of hangers 32 and 34 having vertical elements 35 and 36 defining a void for introducing long articles. The hangers 32 and 34 may be secured to the ends of the rod 22 by means of pins 26 inserted through drillings spaced from ends of the rod 22 and corresponding drillings in tubular extensions 27 integrated on said hangers 32 and 34. FIG. 6 shows the carrier assembly being used to carry long pieces of lumber.

In another embodiment (not shown), the hangers 32 and 34 may be used to support an elongated planer member having a walled perimeter. The elongated member is sized such that each end is supported by one the hangers 32 and 34. In this manner, the carrier assembly may be used like a tool box for conveniently carrying any number of items from place to place.

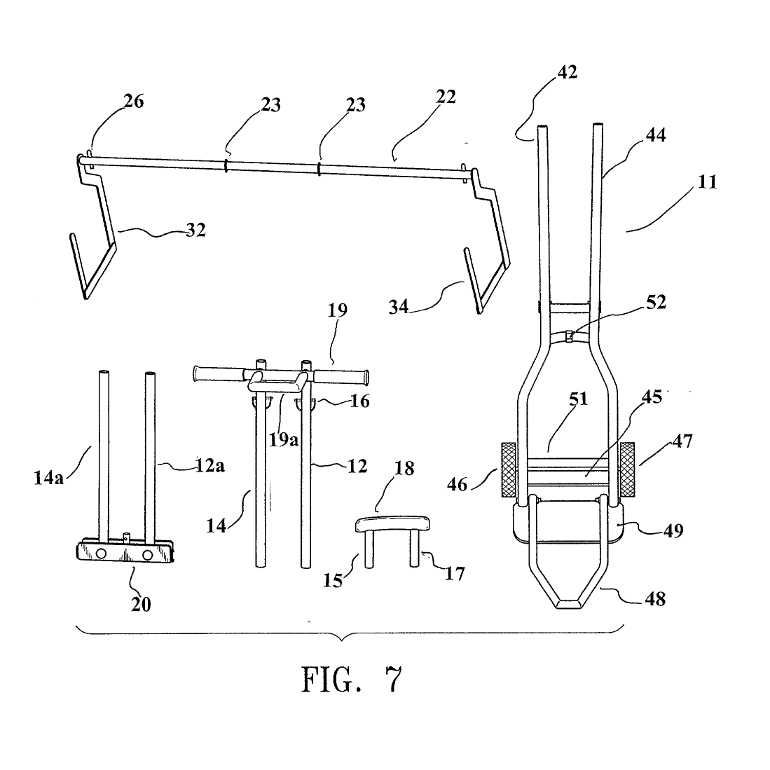

Now referring to FIG. 7a disassembled carrier assembly 10 and dolly assembly 11 are shown. The first set of parallel tubular segments 12 and 14 and the second set of parallel tubular segments 12a and 14a are shown individually. The padded adjustable cross piece 18 is also shown individually. The rod 22 is shown having the hangers 32 and 34 connected thereto. The dolly assembly 11 is defined by two vertical posts 42 and 44 fixed at their lower ends to a common axle assembly 45 from which a set of dolly wheels 46 and 47 depend. An orthogonal support panel 49 extends in cantilever from the axle structure 45 for lifting and supporting articles. A rotatable extension 48 is attached to lower ends of the vertical posts 42 and 44 providing additional lifting area if required. A clamp 52 retains the rotatable extension 48 during non-use. A lower traverse member 51 provides a foot-planting area for tilting the dolly assembly 11 rearward during use.

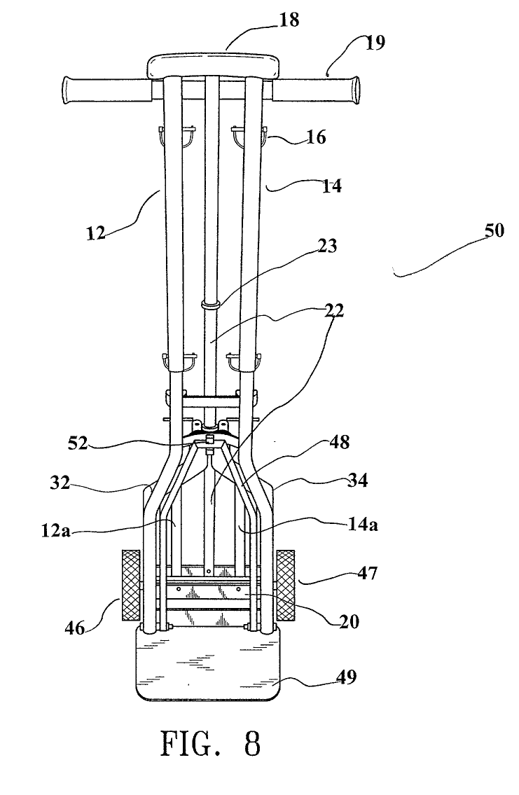

As illustrated in particular in FIG. 8, the individual elements may be assembled to form a dolly 50. The assembly of the individual elements shown in FIG. 7 is accomplished by inserting the vertical posts 42 and 44 into the tubular segments 12 and 14 such that the handle piece 19 is adjacent an upper portion of the dolly 50 and can be used to control the dolly 50. The tubular segments 15 and 17 of the padded cross piece 18 are then inserted into opposite ends of the tubular segments 12 and 14. Elongated pins 16 in combination with a plurality of drillings secure the combination of the tubular segments 12 and 14, vertical posts 42 and 44, and the cross piece 18. The second set of parallel tubular segments 12a and 14a having the U-shaped channel 20 is then positioned upon an inner shelf of the lower traverse member 51. To provide more structural integrity, the segments 12a and 14a are removably restrained by clamps 53 supported by an angled traverse member 57.

Thereafter, the hangers 32 and 34 are removed from the rod 22. The hangers 32 and 34 are oppositely placed within the U-shaped channel 20 with said tubular extensions 27 facing rearward. A first end of the rod 22 removably engages a tubular extension of the U-shaped channel 20 thereby securing the rod 22.

In this manner, a small complement of interlocking components is rendered useful to accommodate the variety of lifting and moving tasks that one encounters at a construction site. The user, therefore, needs to invest in only a single carrier and assembly which is then useful for virtually all of the functions required. As a result, the number of tools cluttering a work-site is reduced in an assembly that is easily fabricated and conveniently used.

Obviously, many modifications and variations of the above teachings can be effected without departing from the spirit of the invention disclosure herein. For example, the elongated pins 16 can be replaced with spring-biased pins or other telescoping means. Therefore it is intended that the scope of the invention be determined solely by the claims appended hereto.

I claim:

1. A carrier assembly useful in assisting in the movement of articles, comprising:
a generally rectangular central frame defined by a pair of substantially parallel tubular segments joined at one ends thereof by a padded cross piece conformed for receipt in the armpit of a person and bridged proximate the other ends thereof by an offset transverse handle piece; and
a panel carrier assembly releasably engaged to said other ends of said tubular segments defined by equally spaced, parallel posts conformed for receipt in the corresponding other ends of said tubular segments at the upper ends thereof and affixed at their lower ends to a transverse channel.

2. The carrier assembly according to claim 1, wherein each said tubular segment is adjustable in length.

3. The carrier assembly according to claim 1, wherein the traverse handle piece incorporates a void defining handle member.

4. The carrier assembly according to claim 1, wherein said cross piece and said handle piece are separated from each other by a dimension substantially equal to the arm length of said person.

5. The carrier assembly according to claim 1, wherein said cross piece is adjustable for varying the distance between the cross piece and the handle piece.

6. The carrier assembly according to claim 4, wherein each said tubular segment is adjustable in length.

7. The carrier assembly according to claim 1, wherein said transverse channel is conformed to receive an edge of a structural panel.

8. The carrier assembly according to claim 7, wherein each said tubular segment is adjustable in length.

9. The carrier assembly according to claim 1, further comprising a first and second hanger each respectively engageable for suspension from corresponding ends of an elongated rod, said rod secured longitudinally within the traverse channel.

10. The carrier assembly according to claim 9 further including an elongated planer member having a walled perimeter, said planer member being supported by said hangers.

11. The carrier assembly according to claim 1, further comprising a first and second hanger each respectively engageable for suspension from corresponding ends of an elongated rod, said rod inserted and secured longitudinally through the hollow traverse handle piece.

12. The carrier assembly according to claim 11, wherein said rod includes an alignment stop circumscribing said rod.

13. The carrier assembly according to claim 11, further including an elongated planer member having a walled perimeter, said planer member being supported by said hangers.

14. The carrier assembly according to claim 1, wherein said carrier assembly is incorporated into a mobile dolly assembly.

15. A carrier assembly useful in assisting a person in the movement of articles, comprising:
a generally rectangular central frame defined by a pair of substantially parallel tubular segments joined at one ends thereof by a cross piece and bridged proximate the other ends thereof by an offset transverse handle piece; and
a dolly assembly releasably engaged to said other ends of said tubular segments and defined by parallel posts each conformed for receipt in the corresponding other end of said segments at the upper ends thereof and secured to a transverse axle assembly at the lower ends thereof, said axle assembly including wheels mounted for rotation for providing rolling support over ground.

16. The carrier assembly according to claim 15, wherein each said tubular segment is adjustable in length.

17. The carrier assembly according to claim 15, further including means for incorporating therewithin an elongated rod and a first and second hanger each respectively engageable for suspension from corresponding ends of the elongated rod.
